(19) United States
(12) Patent Application Publication
(10) Pub. No.: US 2008/0257426 A1
(43) Pub. Date: Oct. 23, 2008

(54) INTEGRAL HINGE

(76) Inventors: Kenneth M. Spink, Horton, MI (US); Paul D. Walkowski, Ann Arbor, MI (US); James R. Fries, Fenton, MI (US); Ronald E. Sexton, South Lyon, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/737,337

(22) Filed: Apr. 19, 2007

(51) Int. Cl. F16K 15/03

(52) U.S. Cl. 137/527; 137/511; 29/890.12

(57) ABSTRACT

A valve is provided. The valve may include a housing defining a cavity. A first end of the housing may define an opening configured to be closed by a flapper door. The valve may further include a hinge formed integrally with the housing. The hinge may extend from an upper portion of the housing and be configured to receive the flapper door. In an embodiment, at least a portion of the hinge extends beyond the opening. The hinge may provide a pivot point for the flapper door that is at or above the opening of the housing.

### BACKGROUND

a. Field of Invention

The invention relates generally to a valve having an integral hinge configured to receive a flapper door, including a valve having an integral hinge configured to receive a flapper door where the hinge extends at least in part above the opening configured to be closed by the flapper door.

b. Description of Related Art

In line check valves and flapper type valves may be employed in a number of applications. For example, in line check valves and flapper type valves may be employed in a fuel tank filler tube for accommodating insertion of a refueling nozzle and providing for closure and sealing of the filler tube upon removal of the nozzle at the completion of refueling. In line check valves may be costly and the in line piston impedes the fluid flow, causing a greater pressure drop and premature shut-offs when filling the fuel tank rapidly. Flapper type valves generally include a valve housing and a hinge that may be used to connect a flapper door to the valve housing. In many flapper type valves, the hinge may be a separate piece that must be assembled to the valve housing. This requires an increased number of components in order to retain the flapper door to the valve housing and results in a complex assembly process. Furthermore, the use of a separate hinge results in a high risk of accidental disassembly of the hinge and flapper door from the valve housing during drop, shock, splash, or crash scenarios. In some flapper type valves, the hinge may comprise deflectable fingers that must be moved in order to insert the flapper door during assembly. Deflectable fingers provide a high risk of unintentional movement from a desired holding point of the fingers in a working environment due to external conditions, such as vibration or heat. In other flapper type valves, the hinge may extend below the opening configured to be closed by the flapper door, such that the pivot point of the flapper door is below the opening configured to be closed by the flapper door.

There is a desire for a valve that may minimize and/or eliminate these deficiencies.

### SUMMARY

A valve is provided. The valve may include a housing defining a cavity. A first end of the housing may define an opening configured to be closed by a flapper door. The valve may further include a hinge formed integrally with the housing. The hinge may extend from an upper portion of the housing and be configured to receive the flapper door. In an embodiment, at least a portion of the hinge extends above the opening. The hinge may provide a pivot point for the flapper door that is at or above the opening of the housing.

Various features of this invention will become apparent to those skilled in the art from the following detailed description, which illustrates embodiments and features of this invention by way of non-limiting examples.

### BRIEF DESCRIPTION OF THE DRAWINGS

Embodiments of the invention will now be described, by way of example, with reference to the accompanying drawings, wherein.

FIG. 1 is a perspective view of a valve in accordance with an embodiment of the invention.

FIG. 2 is a top cross-sectional view of a valve in accordance with an embodiment of the invention.

FIG. 3 is a side cross-sectional view of a valve in accordance with an embodiment of the invention.

FIG. 4 is a perspective view of a valve in accordance with an embodiment of the invention, her illustrating a flapper door.

### DETAILED DESCRIPTION

Reference will now be made in detail to embodiments of the present invention, examples of which are illustrated in the accompanying drawings. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as embodied in or defined by the appended claims.

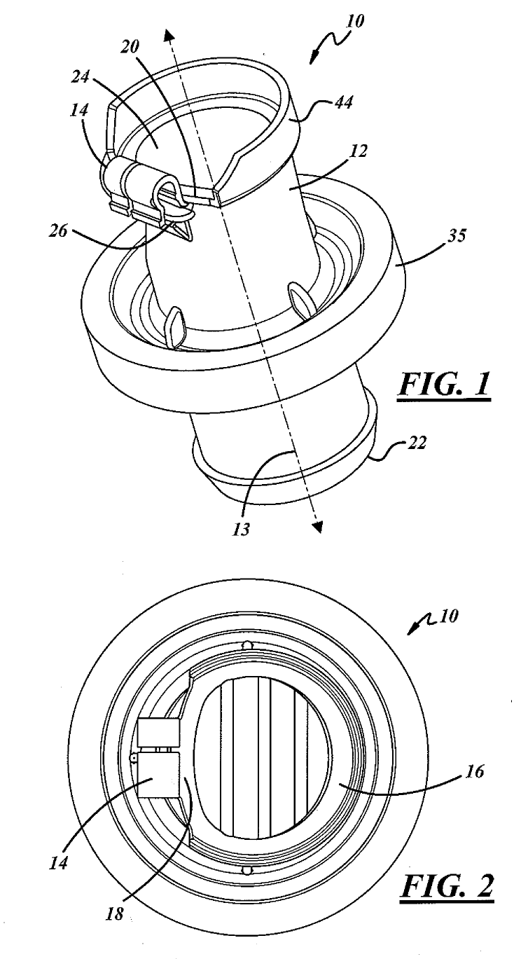

Referring now to FIG. 1 which illustrates a perspective view of a valve 10 in accordance with an embodiment of the invention, valve 10 includes housing 12 and hinge 14. Although valve 10 may comprise a check valve for use in a fuel tank filler tube or fuel tank of a motor vehicle in an embodiment of the invention, it is understood by those of ordinary skill in the art that inventive valve 10 may comprise any valve for any of various uses and remain within the spirit and scope of the invention. Valve 10 be used and/or mounted in a horizontal, vertical, or angled orientation.

Housing 12 may be provided for structural support of the components of valve 10. Housing 12 of valve 10 may have a longitudinal axis 13. Housing 12 may be a tubular body and may be cylindrical or generally cylindrical in shape. In an embodiment, housing 12 may include a generally D-shaped cross-section. Referring now to FIG. 2, housing 12 may include a generally curved wall portion 16 on a first side of housing 12 and may include a generally flat wall portion 18, relative to curved wall portion 16, on a second side of housing 12. Although a D-shaped cross-section is mentioned in detail, it is understood by those of ordinary skill in the art that any of various shapes and configurations may be used for housing 12 and remain within the spirit and scope of the invention. Referring again to FIG. 1, housing 12 may include a first end 20 and a second end 22. First end 22 may define an opening 24. Opening 24 may be configured to be closed by a flapper door as described in more detail below.

Referring now to FIGS. 1 and 3, in an embodiment, housing 12 may include a flange 26. Flange 26 may be located on an exterior surface of housing 12 on generally flat wall portion 18 and may be located below hinge 14. Flange 26 may be provided to prevent spring 52 from moving side to side and nesting backward. Housing 12 may be molded, for example, from a plastic. In an embodiment, at least a portion of housing 12 may comprise high density polyethylene (HDPE). In other embodiments, at least a portion of housing 12 may comprise acetal, nylon, or a model. Although these materials are mentioned in detail, it is understood by those of ordinary skill in the art that numerous other materials may be used to form housing 12 and remain within the spirit and scope of the invention.

In an embodiment, housing 12 may have a uniform wall thickness. The uniform wall thickness may extend both circumferentially around housing 12 and longitudinally up and down housing 12 at any height of housing 12. In another embodiment, housing 12 may have a variable wall thickness. In an embodiment, at least a portion of housing 12 at a first height may have a first thickness 28 and at least a portion of housing 12 at a second height may have a second thickness 30. Second thickness 30 may be greater than first thickness 28, for example. Second thickness 30 may be greater than first thickness 28 in order to provide stiffening support to housing 12 and/or to compensate for warp that may occur when housing 12 is in its working environment or plastic shrinkage during molding, for example. Second thickness 30 may be located at or near the bottom of housing 12 as shown in its orientation in FIG. 3.

Housing 12 defines a cavity 32. Cavity 32 may be defined by the inner surface of housing 12. In an embodiment, cavity 32 may have a first diameter 34 at a first height of housing 12 and may have a second diameter 36 at a second height of housing 12. First diameter 34 may be at a height of housing 12 corresponding to a portion of housing 12 formed by a first mold piece during a molding operation. Second diameter 36 may be at a height of housing 12 corresponding to a portion of housing 12 formed by a second mold piece during a molding operation. Second diameter 36 may be greater than first diameter 34, for example.

Housing 12 may include a radially outwardly extending annular flange 35 located between first end 20 and second end 22. Annular flange 35 may form a groove adapted for receiving a resilient seal ring therein.

Hinge 14 may be provided to receive at least a portion of a flapper door. In an embodiment, hinge 14 may alone define a channel for receiving at least a portion of a flapper door. Hinge 14 may be formed integrally with housing 12. A separate hinge pin and/or hinge housing may not be included in valve 10, thereby reducing the number of required components and lowering cost. Hinge 14 may extend from housing 12, and may extend from an upper portion of housing 12. For example, in an embodiment, hinge 14 may extend from at or about a top one third of housing 12. In another embodiment, for example, hinge 14 may extend from first end 20 of housing 12. Hinge 14 may extend upwardly. In an embodiment, at least a portion of hinge 14 extends beyond (e.g., above) opening 24. Accordingly, hinge 14 may provide a pivot point for the flapper door that is at or above opening 24 of housing 12. Sealing of valve 10 (i.e., through closure of opening 24 by a flapper door) may be improved when the pivot point for the flapper door is at or above opening 24 of housing 12. Hinge 14 may extend from generally flat wall portion 18 on a second side of housing 12. Hinge 14 may extend outwardly (i.e., away) from housing 12. Hinge 14 may have a generally I-shaped or U-shaped cross-section. Hinge 14 may be rigid (i.e., configured to receive a flapper door without substantial deflection or separation of hinge 14 from housing 12).

In an embodiment, hinge 14 may include formation 36 at one end of hinge 14 for preventing the flapper door from disassembling from housing 12. Formation 36 may extend outwardly (i.e., away) from the portion of hinge 14 configured to receive the flapper door. Formation 36 may comprise a hook, for example. Although a hook is mentioned in detail, it is understood by those of ordinary skill in the art that various other formations may be used for preventing the flapper door from disassembling from housing 12 and remain within the spirit and scope of the invention. It is also understood by those of ordinary skill in the art that formation 36 may not be used in connection with hinge 14 and remain within the spirit and scope of the invention. An inner surface 38 of hinge 14 may include at least one protrusion 40 for preventing disengagement of a flapper door from housing 12. Protrusion 40 may be generally trapezoidal in shape as illustrated in FIGS. 1 and 3. Protrusion 40 may include a lead in taper that may improve easy of assembly and its shape may hinder pulling apart hinge 14. In an embodiment, inner surface 38 of hinge 14 may include first protrusion 40 and second protrusion 42, both for preventing disengagement of the flapper door from housing 12. First protrusion 40 may oppose second protrusion 42. First and second protrusions 40, 42 may be generally trapezoidal in shape as illustrated in FIGS. 1 and 3. Although one or more protrusions 40, 42 are mentioned in detail and a trapezoidal shape for these protrusions are mentioned in detail, it is understood by those of ordinary skill in the art that inner surface 38 may not have one or more protrusions and/or may have protrusions of any of various shapes and remain within the spirit and scope of the invention.

In an embodiment, valve 10 may include a shroud 44 for protecting components of valve 10. Shroud 44 may be formed integrally with housing 12. Shroud 44 may extend from housing 12, and for example, may extend from generally curved wall portion 16 on a first side of housing 12. Shroud 44 may extend upwardly from first end 20 of housing 12. Shroud 44 may extend at least about 180° around first end 20 of housing 12. Although a shroud extending approximately 180° around first end 20 of housing 12 is mentioned in detail, it is understood by those of ordinary skill in the art that valve 10 may not include a shroud or may include a shroud that extends less than or more than 180° around first end 20 of housing 12 and remain within the spirit and scope of the invention.

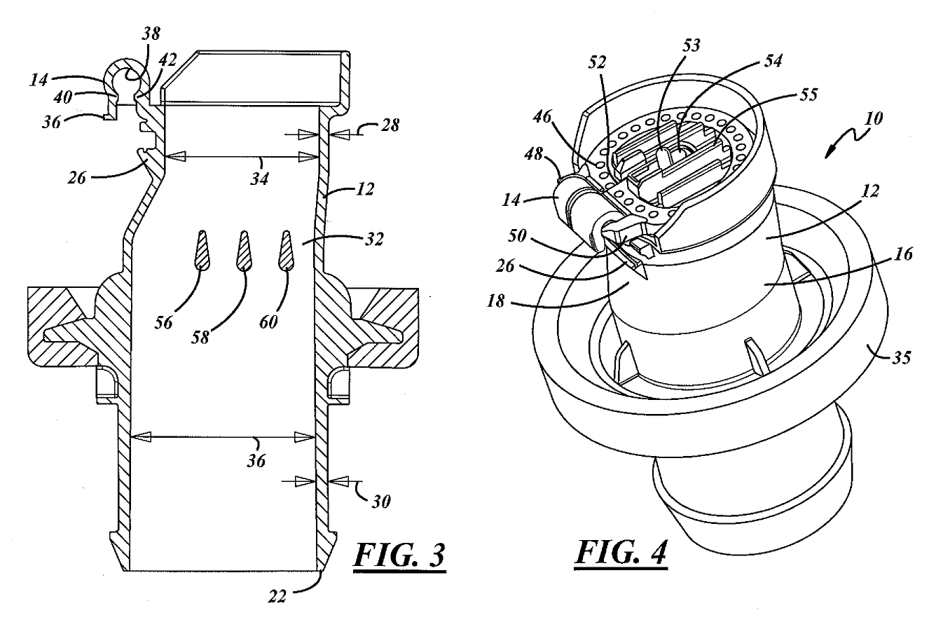

Referring now to FIG. 4, flapper door 46 may be provided for connection to housing 12. Flapper door 46 may also be referred to as a flapper or door. Flapper door 46 may be configured for connection to hinge 14 (e.g. flapper door 46 may be configured to snap into hinge 14). Flapper door 46 may move (e.g., rotate) between about 0° and about 90° relative to longitudinal axis 13 of housing 12 of valve 10 in order to open and close opening 24 of housing 12. Flapper door 46 may have a pair of lugs 48, 50 projecting outwardly or inwardly therefrom. Lugs 48, 50 may be spaced parallel to each other and may be on opposite sides of flapper door 46. Each lug 48, 50 may have a trunnion extending therefrom in an axially aligned relationship and extending toward the midpoint between lugs 48, 50. One of the lugs 48, 50 (e.g., the trunnion of one of the lugs 48, 50) may be provided with an axially extending spindle portion (not shown) of reduced diameter which has the coil of a torsion spring 52 received thereover. Flapper door 46 may have a post 53 located in the central region of flapper door 46 and extending outwardly therefrom. Post 53 may be located on a line perpendicular to the axis of the trunnions and passing through the spindle. Flapper door 46 may also include at least one rib 55 extending from flapper door 46. Rib 55 may extend upwardly from flapper door 46. In an embodiment, flapper door 46 may include a plurality of spaced ribs 55 extending from flapper door 46. Ribs 55 may be generally parallel to each other and spaced generally equidistant from each other. Ribs 55 may be provided to prevent a siphon from damaging the flapper door seal by contacting flapper door 46.

Spring 52 may be provided in connection with valve 10. At least a portion of spring 52 may be disposed below hinge 14. Spring 52 has one end thereof formed to a hook-shaped configuration 54. Hook shaped configuration 54 may be slidably registered against post 53 for locating the coil of spring 52 on the spindle. A ridge extending along about the centerline of flapper door 46 may keep the spring force in the center of flapper door 46 in order to compress a seal along the entire circumference of flapper door 46. The other end of spring 52 (i.e., free end) may be rotated by about 90°, for example, with respect to hook-shaped configuration 54, and thereby may provide a torsional preload on flapper door 46 to bias flapper door 46 in a direction to close opening 24. Although 90° is mentioned in detail, it is understood by those of ordinary skill in the art that the free end of spring 52 may be rotated by about 100°, by about 180°, or by any other amount in order to provide a desired spring tension, and remain within the spirit and scope of the invention. Spring 52 may be configured such that the bias force applied to flapper door 46 is low enough such that the force may be overcome by force of flow (e.g., fuel flow) to overcome the spring bias and move flapper door 46 away from opening 24 of housing 12. A pivot point for spring 52 may be at or below the pivot point for flapper door 46. Accordingly, the amount of force against flapper door 46 may be lowered when flapper door 46 is opened, thereby lessening the flow back pressure at high flow rates. Valve 10 may further comprise a hinge pin (not shown). At least a portion of the hinge pin may be disposed below hinge 14.

Referring again to FIGS. 1 and 3, valve 10 may further comprise at least one fin 56 in an embodiment. Fin 56 may extend across cavity 32 for impeding siphoning of liquid controlled by valve 10. In one embodiment, fin 56 may be used for impeding siphoning of fuel from a fuel tank in which valve 10 has been utilized. Valve 10 may further comprise a plurality of fins 56 in another embodiment. For example, fins 56, 58, 60 are illustrated in FIG. 3. Although three fins 56, 58, 60 are mentioned in detail, it is understood by those of ordinary skill in the art that more or fewer fins may be used with valve 10 and remain within the spirit and scope of the invention. Fins 56, 58, 60 may extend generally parallel to hinge 14. Fins 56, 58, 60 may be spaced generally equally from each other, all generally parallel to hinge 14. Although these configurations are mentioned in detail, it is understood by those of ordinary skill in the art that other configurations of fins 56, 58, 60 may be utilized and remain within the spirit and scope of the invention. Fin 50 may have a generally fish-shaped cross-section for lowering the coefficient of drag of fin 50 in order to minimize the pressure drop imparted on the fluid (e.g., fuel) passing through valve 10. This may assist in preventing premature shut-off during fuel fill-up, for example. In accordance with a fish-shaped cross-section, fin 50 may have a first width 56 at a first height of fin 50 and a second width 58 at a second height of fin 50. Accordingly, the sides of fin 50 may be tapered from a first width to a second width.

A method of forming a valve 10 is also provided. The method may include forming a valve 10 having a housing 12 that defines a cavity 32 and having a rigid hinge 14 formed integrally with housing 12. A first end 20 of housing 12 may define an opening 24 configured to be closed by a flapper door 46. At least a portion of hinge 14 may extend beyond opened 24 and may be configured to receive flapper door 46. The method of forming valve 10 may comprise using a first and second mold piece that meet at a parting line, and in particular, at a parting line plane that is generally perpendicular to the longitudinal axis 13 of housing 12 of valve 10. The method may further include connecting flapper door 46 to housing 12 of valve 10 by engaging flapper door 46 and hinge 14.

The method may include molding at least one fin 56 that extends across cavity 32. The method of forming fin 56 may comprise using a first and second core pin that meet at a parting line, and in particular, at a parting line plane that is generally perpendicular to the longitudinal axis 13 of housing 12 of valve 10. The first core pin may be configured to form a first portion of fin 56. The second core pin may be configured to form a second portion of fin 56. Accordingly, fin 56 may be at least partially disposed in the parting line plane.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims and their equivalents.

What is claimed is:

1. A valve, comprising:
a housing defining a cavity, wherein a first end of the housing defines an opening configured to be closed by a flapper door; and
a hinge formed integrally with the housing, the hinge extending from an upper portion of the housing and configured to receive the flapper door,
wherein at least a portion of the hinge extends above the opening.

2. A valve in accordance with claim 1, wherein the hinge is rigid.

3. A valve in accordance with claim 1, further comprising a flapper door configured for connection to the housing.

4. A valve in accordance with claim 3, wherein the flapper door rotates between about 0° and about 90° relative to a longitudinal axis of the valve.

5. A valve in accordance with claim 1, further comprising a shroud formed integrally with the housing, wherein the shroud extends at least about 180° around the first end of the housing.

6. A valve in accordance with claim 1, wherein the hinge extends outwardly from the housing.

7. A valve in accordance with claim 1, wherein the hinge has a generally J-shaped or U-shaped cross-section.

8. A valve in accordance with claim 3, wherein the hinge includes a formation at one end for preventing the flapper door from disassembling from the housing.

9. A valve in accordance with claim 3, wherein an inner surface of the hinge includes at least one protrusion for preventing disengagement of the flapper door from the housing.

10. A valve in accordance with claim 9, wherein the protrusion is generally trapezoidal in shape.

11. A valve in accordance with claim 3, wherein an inner surface of the hinge includes a first and second protrusion for preventing disengagement of the flapper door from the housing.

12. A valve in accordance with claim 11, wherein the first protrusion opposes the second protrusion.

13. A valve in accordance with claim 3, wherein the flapper door is configured to snap into the hinge.

14. A valve in accordance with claim 1, further comprising a flange located on an exterior surface of the housing below the hinge.

15. A valve in accordance with claim 1, further comprising at least one fin extending across the cavity for impeding siphoning of liquid controlled by the valve.

16. A valve in accordance with claim 1, comprising a plurality of fins extending across the cavity.

17. A valve in accordance with claim 15, wherein the fin extends generally parallel to the hinge.

18. A valve in accordance with claim 15, wherein the fin has a first width at a first height and a second width at a second height, wherein the second width is greater than the first width.

19. A valve in accordance with claim 1, wherein the valve has a first inner diameter at a first height and a second inner diameter at a second height, wherein the second inner diameter is greater than the first inner diameter.

20. A valve in accordance with claim 1, wherein at least a portion of the housing at a first height has a first thickness and at least a portion of the housing at a second height has a second thickness, wherein the second thickness is greater than the first thickness.

21. A valve in accordance with claim 15, wherein the valve is formed using a first mold piece and a second mold piece, the first and second mold pieces meeting in a horizontal plane relative to the longitudinal axis of the valve, and wherein the fin is at least partially in the horizontal plane.

22. A valve in accordance with claim 3, further comprising a spring at least partially disposed below the hinge, wherein the hinge provides a pivot point for the flapper door that is at or above the opening of the housing and is at or above a pivot point for the spring.

23. A valve in accordance with claim 3, wherein the flapper door includes at least one rib extending from a surface of the flapper door.

24. A check valve for use in a fuel tank of a motor vehicle, comprising:
a valve housing defining a cavity, wherein a first end of the housing defines an opening configured to be closed by a flapper door;
a hinge formed integrally with the housing, the hinge extending from the housing and configured to receive the flapper door;
at least one fin extending across the cavity for impeding siphoning of fuel from the fuel tank of the motor vehicle,
wherein at least a portion of the hinge extends above the opening.

25. A check valve in accordance with claim 24, wherein the fin has a first width at a first height and a second width at a second height, wherein the second width is greater than the first width.

26. A method of forming a valve, comprising:
molding the valve using a first and second mold piece that meet at a parting line plane, the valve comprising a housing that defines a cavity and a hinge formed integrally with the housing, wherein a first end of the housing defines an opening configured to be closed by a flapper door and at least a portion of the hinge extends from and upper portion of the housing above the opening and is configured to receive the flapper door.

27. A method in accordance with claim 26, further comprising:
connecting the flapper door to the housing by engaging the flapper door and the hinge.

28. A method in accordance with claim 26, further comprising:
molding at least one fin that extends across the cavity using a first and second core pin, wherein the first core pin is configured to form a first portion of the fin and the second core pin is configured to form a second portion of the fin and wherein the first and second core pins meet at the parting line plane.
